(19) United States
(12) Patent Application Publication
(10) Pub. No.: US 2024/0223381 A1
(43) Pub. Date: Jul. 4, 2024

(54) POST-QUANTUM CRYPTOGRAPHY SIGNATURE VERIFICATION

(71) Applicant: Intel Corporation, Santa Clara, CA (US)

(72) Inventors: Alan Hwang, New York, NY (US); Solmaz Ghaznavi, Portland, OR (US); Santosh Ghosh, Hillsboro, OR (US)

(73) Assignee: Intel Corporation, Santa Clara, CA (US)

(21) Appl. No.: 18/157,272

(22) Filed: Jan. 20, 2023

Related U.S. Application Data
(60) Provisional application No. 63/477,584, filed on Dec. 29, 2022.

(51) Int. Cl. H04L 9/32; H04L 9/30

(52) U.S. Cl. CPC H04L 9/3247; H04L 9/30; H04L 9/3236

(57) ABSTRACT

Techniques for performing digital signature verification are described. Digital signature verification circuitry includes a memory; and signature verification circuitry, including Secure Hash Algorithm (SHA) circuitry; message representative generator circuitry; tree verification circuitry; and hypertree verification circuitry.

### CROSS-REFERENCE TO RELATED APPLICATION

This application claims the benefit of U.S. Provisional Patent Application No. 63/477,584, filed Dec. 29, 2022, which is incorporated by reference herein in its entirety.

### BACKGROUND

The intractability assumption of the computational problems that common classical digital signature schemes (e.g., Digital Signature Algorithm (DSA), Rivest-Shamir-Adleman (RSA), and Elliptic Curve Digital Signature Algorithm (ECDSA) in Digital Signature Standard FIPS 186-4, 80 FR 63539, Oct. 10, 2015) rely on will be broken by quantum computers. New methods of implementing digital signatures that are resistant to attacks by quantum computers are needed.

### BRIEF DESCRIPTION OF DRAWINGS

Various examples in accordance with the present disclosure will be described with reference to the drawings.

FIG. 1 is a block diagram of a computing system in one implementation.

FIG. 2 is a block diagram of an accelerator in one implementation.

FIG. 3 illustrates signature verification circuitry according to an implementation.

FIG. 4 illustrates signature verification processing according to an implementation.

FIGS. 5A and 5B illustrate hypertree generation processing according to an implementation.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, and systems to perform digital signature verification in signature verification circuitry in a computing system. According to some examples, the signature verification circuitry implements signature verification processing in a processor as described by the SPHINCS+ process. SPHINCS+ is a quantum-secure verification algorithm that can be used, for example, for firmware authentication purposes. Given a public key, message, and signature, the SPHINCS+ algorithm validates the corresponding digital signature and verifies data integrity.

SPHINCS+ is a stateless hash-based signature process, as described by the SPHINCS+ submission to the National Institute of Standards and Technology (NIST) post-quantum project, version 3.1, Jun. 10, 2022. The SPHINCS+ process proposes three different signature schemes: 1) SPHINCS⁺-SHAKE256 (an extendable-output function (XOF) in the Secure Hash Algorithm 3 (SHA-3) family, as specified in the SHA-3 standard, “Permutation-Based Hash and Extendable-Output Functions”, Federal Information Processing Standards (FIPS) 202, August 2015); 2) SHA-256 (a Secure Hash Algorithm (SHA), as specified in the SHA-256 standard, “Secure Hash Standards”, FIPS 180-4, August 2015; and 3) SPHINCS⁺-Haraka (for example, as described in “Haraka, version 2, Efficient Short-Input Hashing for Post-Quantum Applications” Stefan Kolb, et al., Oct. 24, 2016). These signature schemes are obtained by instantiating the SPHINCS⁺ construction with SHAKE256, SHA-256, and Haraka, respectively.

SPHINCS+, which is a hash-based signature (HBS) scheme, will be standardized for digital signatures. The security of SPHINCS+ relies only on well-known one-way cryptographic hash functions and has the property of being stateless. However, SPHINCS+ is typically based on a software implementation performing approximately 20,000 hash executions, resulting in a long execution latency (e.g., approximately 20 million cycles). The long execution latency of SPHINCS+ is a disadvantage for practical deployment in applications in computing systems. In an implementation described herein, SPHINCS+ is implemented in signature verification circuitry in a processor or an accelerator optimized for improved latency and area usage.

The technology described herein includes optimized SPHINCS+ signature verification circuitry with an approximately 184× latency reduction compared to an existing software implementation. To achieve this, three principles are applied. First, the signature verification circuitry implements SPHINCS+-SHAKE256-256s, which is based on a SHAKE256 hash function and provides NIST level 5 security. In an implementation, the lightweight customized SHAKE256 signature verification circuitry disclosed herein is designed to process 24 rounds iteratively on multiple (3, 4, 6) rounds of a data path within one cycle to process a 1,088-bit input or to deliver a 1,088-bit additional output. The result in circuit design has a latency as low as 4 cycles per hash in SPHINCS+, compared to 64 cycles in a trivial hash of SHA256 used in SPHINCS+. Second, integrated wide memory blocks are used with 256-bit read/write ports to access each SPHINCS+ word within a single cycle. Third, parallelized memory reads, hash computations, and memory writes are used to engage the SHAKE256 circuitry without stalls.

In an example, the signature verification circuitry takes 74,228 cycles to compute one instance of SPHINCS+-SHAKE256-256s, compared to 19,292,734 cycles for a software execution on a computing system having an Intel Core i7-4700K processor. Additionally, each intermediate calculation is written to internal memory within the signature verification circuitry, which eliminates the need for an estimated 5,920 bytes of registers in the processor.

According to some examples, the technologies described herein may be implemented in one or more electronic devices. Non-limiting examples of electronic devices that may utilize the technologies described herein include any kind of computing system, mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, disaggregated server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide post-quantum digital signature verification.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

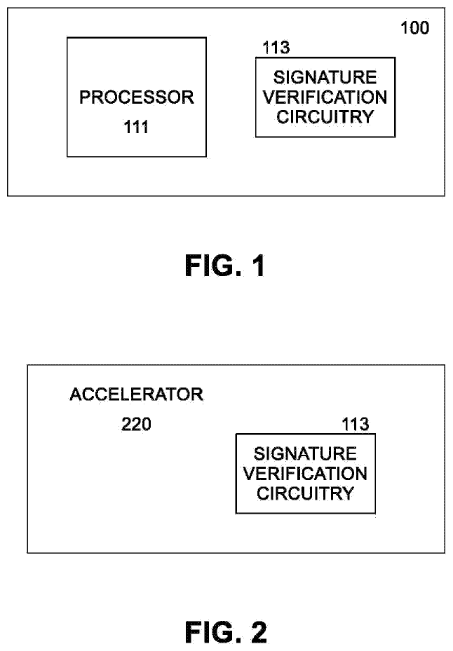

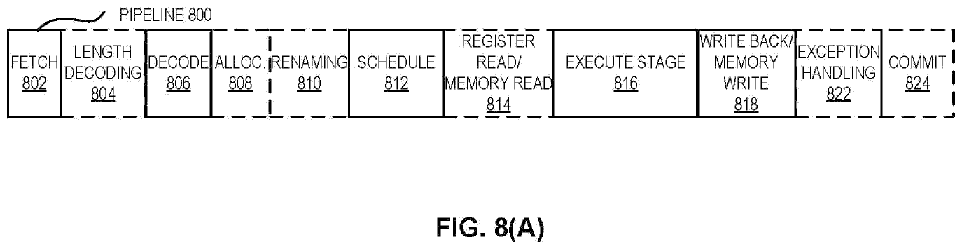

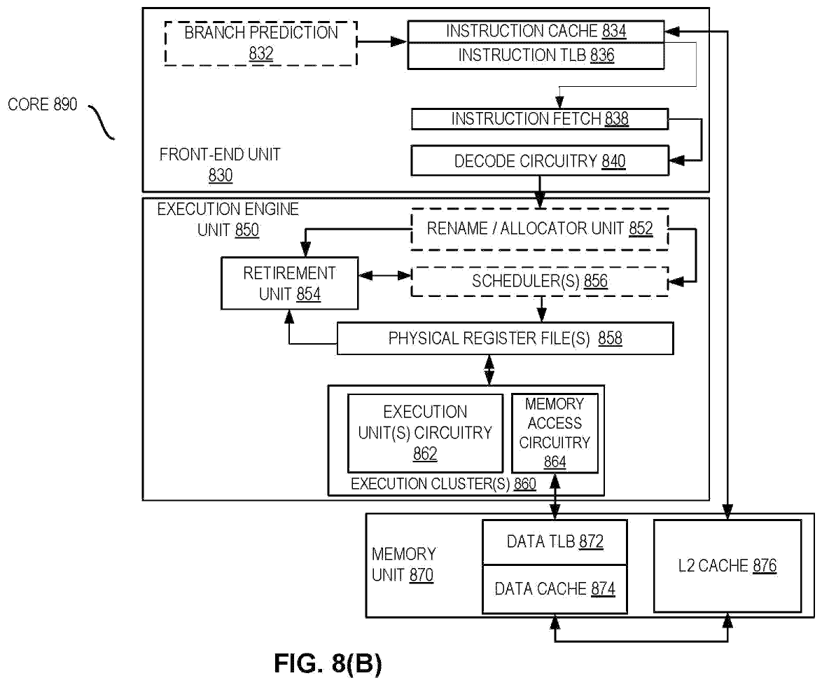

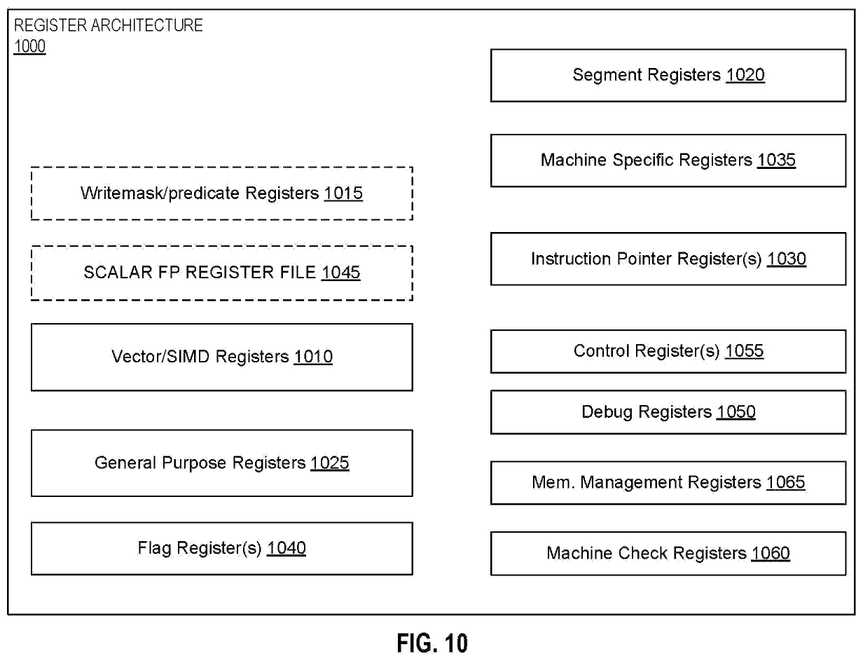

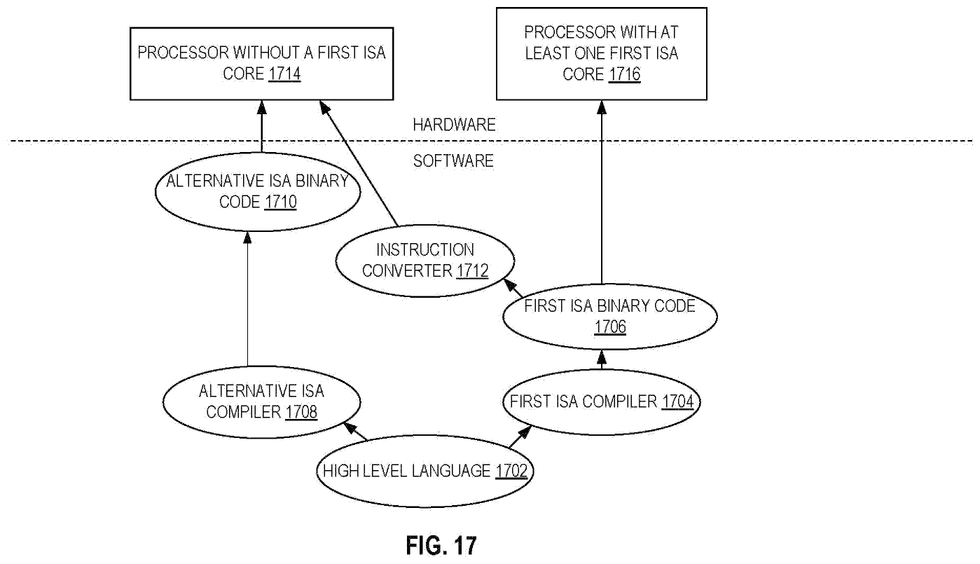

With reference to FIG. 1, an example of a computing system 100 may include a processor 111 to perform data processing operations, and signature verification circuitry 113, coupled to processor 111, to perform digital signature verification operations. For example, processor 111 may be implemented as any of the processors described below. Signature verification circuitry 113 may also be incorporated in processor 111, such as processor 800, processor 870, processor 815, coprocessor 838, and/or processor/coprocessor 880 (FIG. 8), processor 900 (FIG. 9), core 890 (FIG. 8(B)), execution units 1062 (FIGS. 8(B) and 11), and processor 1716 (FIG. 17). In an implementation, signature verification circuitry 113 implements the SPHINCS+ process.

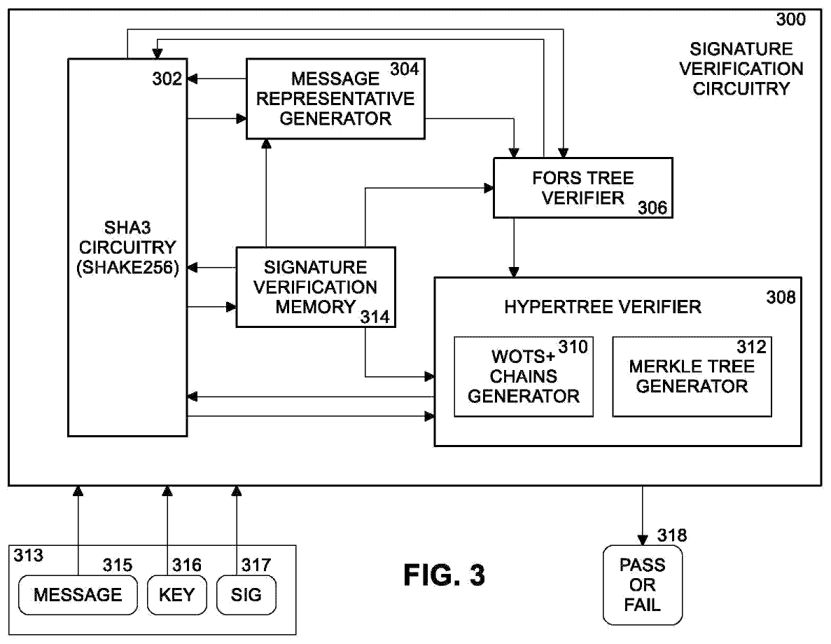

With reference to FIG. 2, an example of an accelerator 220 to perform data processing operations and including signature verification circuitry 113 to perform digital signature verification operations is shown. For example, accelerator 220 may be part of computing system 100.

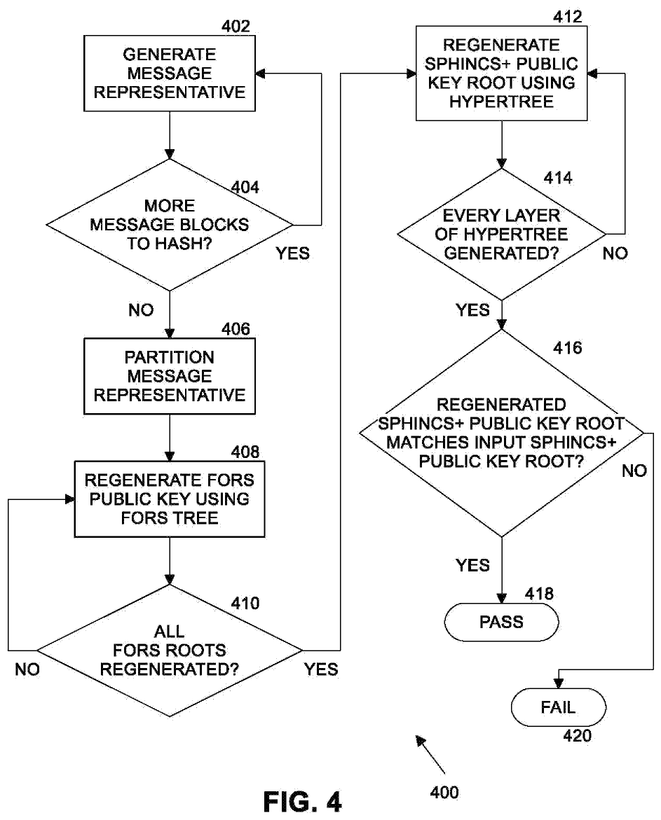

FIG. 3 illustrates signature verification circuitry 300 according to an implementation. Signature verification circuitry 113 is an instance of signature verification circuitry 113 or signature verification circuitry 223. As shown in FIG. 3, signature verification circuitry 300 comprises signature verification memory 314, SHA3 circuitry 302 (e.g., to perform SHA-3 including SHAKE256), and three subcircuits—message representative generator 304, Forest of Random Subsets (FORS) tree verifier 306, and hypertree (HT) verifier 308. Each subcircuit 304, 306, and 308 requires multiple SHAKE256 executions and interacts with SHA3 circuitry 302. While the SHA3 circuitry is running SHAKE256, read and writes of 256 bits are made to signature verification memory 314 to parallelize the computation process and reduce latency. That is, the reading of input data, the performing of the SHAKE256 operations, and writing of output data is executed substantially in parallel.

The proposed SPHINCS+ signature verification circuitry 300 performs SHAKE256 in only 6 cycles. A SPHINCS+ SHAKE256-256s hardware instantiation as shown executes in approximately 74,228 cycles, which is over approximately 260 times faster than the recorded software latency. The SHA3 circuitry 302 allows for parallelism to be exploited—specifically, a three-stage pipeline 304, 306, and 308 linked to signature verification memory 314 internal to signature verification circuitry 300.

This three-stage pipeline is divided into the following operations: (1) a memory read operation, (2) a SHAKE256 execution, and (3) a memory write operation. While SHAKE256 is being computed by SHA3 circuitry 302, data is fetched from signature verification memory 314 to prepare the next input. By the time SHAKE256 has finished its initial operation, a new input is immediately loaded into the SHA3 circuitry for the next execution. This optimization allows for negligible delay between SHAKE256 executions.

The third operation, writing data to signature verification memory 314, allows for the pipelining to be implemented with a minimized area cost. The SPHINCS+ signature verification circuitry 300 described herein writes to signature verification memory 314 after each SHAKE256 operation, eliminating the need for extra registers to hold intermediate calculations. This area optimization saves an estimated 5,920 bytes of extra registers over existing approaches.

SPHINCS+ combines one-time signatures, Merkle trees, hypertrees, and few-times signatures to create a digital signature scheme. SPHINCS+ has three different cryptographic families, defined by its underlying hash function: SHAKE256 (described in FIPS Publication 202), SHA2 256 (described in FIPS Publication 180), and Haraka (a non-standard hash function).

To achieve low latency, in an implementation, the SPHINCS+-SHAKE256 family is implemented in signature verification circuitry 300. In a hardware implementation, SHAKE256 provides a lower latency than SHA256 for each hash operation. The optimized SHA3 circuitry 302 of signature verification circuitry 300 performs 24 rounds of a Keccak-1600 hash function in 6 clock cycles, which provides a 10× lower latency compared to an optimized SHA256 process.

Additionally, SPHINCS+ has different parameter choices that provide a trade-off between signature size and the latency of the signing and verification steps. For each security level, there are two parameter sets: small and fast. Small parameter sets enable a smaller signature at the cost of slower signatures, and fast parameter sets have a larger signature with the benefit of making signatures faster. However, this signature size vs. speed tradeoff is not applicable to the SPHINCS+ verification function, unlike the key generation and signature generation functions. In verification, a small parameter set has both a smaller signature and lower latency than fast parameter sets. With this, SPHINCS+ instantiations with the small parameter set were selected.

By selecting SHAKE256 as the underlying hash function along with small parameter sets, the SPHINCS+-SHAKE256-256s variant is implemented in signature verification circuitry 300. This SPHINCS+ version is classified under NIST's Category 5 security, the strongest security strength category. To qualify for NIST's Category 5 security, the algorithm must be as hard to break as an exhaustive key search on Advanced Encryption Standard (AES) 256.

Signature verification circuitry 300 receives verification input data 313 from another component of computing system 100, such as processor 111, accelerator 220, or other computing system device. Verification input data 313 is stored in signature verification memory 314. Verification input data 313 includes SPHINCS+ message 315, SPHINCS+ public key (key) 316, and SPHINCS+ signature (sig) 317. Using the information contained in the SPHINCS+ signature 317, signature verification circuitry 300 performs a plurality of hash computations on SPHINCS+ message 315 and recomputes a public key root. If the recomputed public key root matches the input SPHINCS+ public key 316, then signature verification passes and a pass indicator is returned as verification output data 318. If the recomputed public key root does not match the input SPHINCS+ public key 316, then signature verification fails and a fail indicator is returned as verification output data 318.

As described in the SPHINCS+ specification, SPHINCS+ signature 317 is divided into three portions: 1) Randomness R (n bytes); 2) FORS signature SIG_{FORS} (k(a+1)*n bytes); and 3) HT signature SIGHT ((h+d len)*n bytes), where n is a security parameter comprises a length of a private key/public key in bytes, k is a number of binary trees in a FORS tree, and d is a number of tree layers in the HT. In an implementation, a SPHINCS+256s signature comprises 29,792 bytes.

As shown in FIG. 3, signature verification circuitry 300 has three main operations: (1) generating a message representative by message representative generator 304; (2) recomputing a FORS tree for the FORS public key by FORS tree verifier 306; and (3) recomputing a hypertree (HT) for the SPHINCS+ public key by hypertree verifier 308.

SPHINCS+ SHAKE256 verification begins with computing the 384-bit message representative (M′) for the entire input message, utilizing SHAKE256 hash operations. By utilizing the three-stage pipeline, the SHA3 circuitry 302 processes an arbitrarily long message with reduced latency and minimal area usage. By writing to the internal memory in signature verification memory 314, a large input message is divided, in an implementation, into multiple blocks of 1,088 bits. These blocks are input into SHA3 circuitry 302 as soon as the blocks are available with no delay in between SHAKE256 operations. Intermediate state calculations are written to signature verification memory 314, removing the need for extra state registers. The message representative (M′) is computed with the following equation:

$${M}^{′} = SHAKE 256 ( R ‖ seed ‖ root ‖ M )$$

R: The randomness variable. It is the first 256 bits of the SPHINCS+ signature.
seed: The public key seed. It is the first 256 bits of the 512-bit SPHINCS+ public key.
root: The public key root. It is 256 bits long and is the second half of the 512-bit SPHINCS+ public key.
M: The message to be hashed, arbitrarily long. (defaults to 256 bits).
M′: The 384-bit output message representative.

Message representative generator 304 reads at least a portion of verification input data 313 from signature verification memory 314. In an implementation, the portion includes SPHINCS+ message 315, SPHINCS+ public key 316, and the first n bytes of SPHINCS+ signature 317 (e.g., randomness R). Message representative generator 304 concatenates SPHINCS+ message 315, SPHINCS+ public key 316, and the first n bytes of SPHINCS+ signature 317 (e.g., randomness R) into a concatenated data item and sends the concatenated data item to SHA3 circuitry 302. SHA3 circuitry 302 performs a SHAKE256 hash on the concatenated data item and outputs the resulting message representative M′ back to message representative generator 304. In an implementation, M′ comprises 384 bits.

Message representative generator 304 passes M′ to FORS tree verifier 306. FORS tree verifier 306 partitions M′ into a FORS digest, a FORS tree index, and a FORS leaf index. The output message representative M′ is partitioned using the following equation:

$${M}^{′} = ( FORS digest ‖ tree\_idx ‖ leaf\_idx ‖ unused )$$

FORS digest: The 312-bit message used in fors_verify.
tree_idx: The 56-bit value used to index the hashes within the FORS tree.
leaf_idx: The 8-bit value used to index the leaves within the FORS tree.
unused: The remaining 8-bits are not used.

FORS tree verifier 306 reads the FORS signature SIG_{FORS} of SPHINCS+ signature 317 from signature verification memory 314. With the FORS digest, FORS tree index, FORS leaf index, and SIG_{FORS}, FORS tree verification may be processed as described in the SPHINCS+ specification. FORS tree verifier 306 sends the FORS digest, FORS tree index, FORS leaf index, and SIG_{FORS} to SHA3 circuitry 302 to perform a plurality of hash operations that reconstruct multiple FORS root nodes necessary for computing the FORS public key.

### FORS Parameters

k: The number of binary trees in the FORS tree.
t: The number of leaves per FORS tree. Must be a power of 2.
a: The height of each binary hash tree.

The FORS digest, tree_idx, leaf_idx, and SPHINCS+ signature are used to recompute the FORS public key through a FORS tree. To divide the FORS digest across k binary trees, the digest is converted from a byte array to a k*log(t) bit string containing index values. The FORS signature (SIG_{FORS}) contains the secret key elements and the associated authentication paths required for recomputing roots. Using the FORS signature derived from the SPHINCS+ signature, the secret key elements are hashed into leaves and are recomputed into subsequent roots. A large hash operation across the top-level binary tree roots recomputes the entire 256-bit FORS public key.

The proposed SPHINCS+ signature verification circuitry utilizes the three-stage pipeline to significantly reduce the latency and minimize area usage for recomputing the FORS public key. Each time SHAKE256 is operating, data is being read from memory to prepare the next input. The cycle that the SHAKE256 circuitry is available for hashing, the next input is already ready to load in. There is little to no delay between SHAKE256 operations, optimizing and reducing the total latency of this computation block. With 660 SHAKE256 invocations, this operation requires an estimated latency of 3,960 clock cycles.

Recomputing the FORS public key requires several bitmasks and roots to be computed. In SPHINCS+-SHAKE256-256s, a 5,632-bit bitmask is computed along with a 6,144-bit root. By writing the intermediate results into a memory module, this SPHINCS+ method reduces the need for extra registers. This optimization also applies for eliminating intermediate registers in between successive SHAKE256 operations, saving an estimated 768 bits. In the FORS computation block, an estimated 12,544 bits of intermediate registers can be saved with this SPHINCS+ method.

The FORS signature (SIG_{FORS}) used for recomputing roots is accessed through the signature verification memory 314. In the SPHINCS+-SHAKE256-256s variant, SIG_{FORS} is k*(log(t)*N)=10,560 bytes. In SPHINCS+-SHAKE256-256s, k=22 binary trees with a tree height of 14, wherein (22*(14+1))=330 tree hashes are needed, resulting in 660 SHAKE invocations for the computation block. The FORS public key computation circuitry invokes SHAKE256 approximately 660 times. Half of the invocations are used to compute bitmasks, while the other half requires reading SIG_{FORS} from signature verification memory 314 to reconstruct the root nodes.

The FORS public key, SPHINCS+ message 315, and SPHINCS+ signature 317 recompute the SPHINCS+ public key 316 through a hypertree (HT). The HT comprises of several layers of Merkle trees. Merkle trees on the top and intermediate layers are used to Winternitz (WOTS+) sign the root nodes of Merkle trees on the respective layer below. The Merkle trees on the bottom layer are used to sign the actual message.

WOTS+ checksums are hashed to recompute the corresponding WOTS+ public keys. 2^{(h/d)} keys are needed to finish verifying a single Merkle tree root. This process is repeated until all Merkle tree roots on the same layer are recomputed. When all roots on a layer are available, they are hashed together to create the leaves of the Merkle tree above it. This process is done until every (d) layer is recomputed. A final hash across the root is performed to obtain the recomputed public key. If this recomputed public key is equivalent to SPHINCS+ public key 316, then verification has passed. If they are not equivalent, the signature is not verified, and the verification process will output a failure signal.

The HT signature (SIGHT) and SPHINCS+ message 315 are used to recompute the HT. In every Merkle tree, WOTS+ chain computations, checksums, and hashes are performed to recompute the corresponding WOTS+ public keys. In verification, the FORS public key verifies the 2\hat{ }h leaves on the bottom layer of the HT (d=0). The top layer d−1 and intermediate layers, d−2 to d=1, are used to verify the corresponding layer of Merkle trees that lie above. This verification process is done in a repeated manner until the top layer d−1 recomputes the root node of the HT (the SPHINCS+ public key root). In SPHINCS+-SHAKE256-256s, there are d=8 hypertree layers. Thus, 8*(15*67+67+8)=8640 tree hashes are invoked, resulting in 17,280 SHAKE256 operations for the HT computation by hypertree verifier 308.

With the pipelining of SHA3 circuitry 302, there is nearly a 100% uptime of SHAKE256 computations. By reading 256-bits of memory every cycle, the next hash input is available early. This creates signature verification circuitry 300 with negligible delay in between SHAKE256 computations. Non-SHAKE256 operations (non-SHA operations) are performed substantially in parallel with the SHA3 circuitry 302, eliminating other extra latency factors. This circuitry invokes 17,280 SHAKE256 operations, equivalent to 103,680 clock cycles. This accounts for 96% of SPHINCS+ signature verification's total latency.

Recomputing the SPHINCS+ public key through the hypertree requires a large bitmask and root. Each operation requires a (67*256)=17,152-bit bitmask, along with another 17,152-bit root. By writing these intermediate calculations into signature verification memory 314, up to 34,816 bits of extra registers can be saved, including the 512-bits saved in between successive SHAKE256 computations.

### HT Parameters:

n: The security parameter, length of private and public key in bytes.
h: The hypertree height.
d: The number of tree layers in the hypertree.
h′: The height of each Merkle tree (h′=h/d).
w: The Winternitz parameter.

In another embodiment, up to three more SHA3 circuits may be added to parallelize the chain computations. If four SHAKE256 operations are executed in parallel, the hypertree latency can be reduced by 4×, from 74,228 clock cycles to 18,557 clock cycles. Because the hypertree computation of hypertree verifier 308 accounts for 96% of the total latency, this modification would increase total performance by 3.8× compared to the singular SHA3 circuitry 302 implementation. With a larger area cost, adding three SHA3 circuits would have a total verification latency of approximately 27,000 cycles. Compared to software's 19,292,734 clock cycles, this reduces latency by approximately 714×.

FORS tree verifier 306 passes the FORS public key to hypertree verifier 308. Hypertree verifier 308 reads HT signature SIGHT of SPHINCS+ signature 317 from signature verification memory 314. Given the FORS public key and SIGHT, hypertree verifier 308 can perform hypertree verification. First, Winternitz One-Time Signature (WOTS+) chains generator 310 takes the FORS public key and verifies 2\hat{ }(h/d) WOTS+ public keys as described in the SPHINCS+ specification. As part of this processing, WOTS+ chains generator 310 sends intermediate hash calculations to SHA3 circuitry 302 and receives intermediate hash calculations from SHA3 circuitry 302 a plurality of times. When 2\hat{ }(h/d) WOTS+ public keys are verified, one Merkle tree has been verified by Merkle tree generator 312. This verification process may be repeated until every Merkle tree is processed for one layer of the hypertree. Once all Merkle trees have been processed for one layer of the hypertree, the process may be repeated for all d layers. When all d layers are processed, a public key root has been recomputed. If the public key root matches the SPHINCS+ public key, then signature verification passes. If not, signature verification fails.

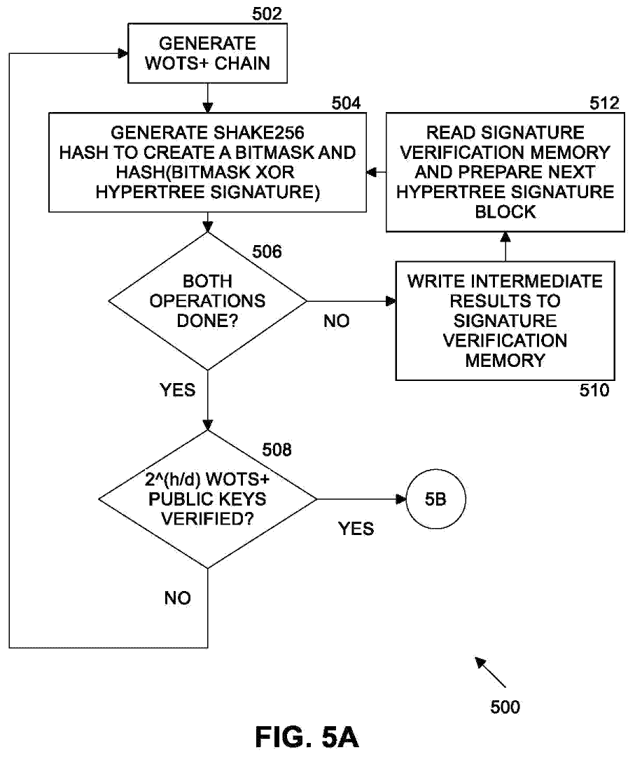

FIG. 4 illustrates signature verification processing 400 according to an implementation. At block 402, message representative generator 304 generates a message representative. In an implementation, generating the message representative is performed by processing one or more blocks of the SPHINCS+ message 315 at a time. At block 404, if more message blocks are to be hashed, then processing continues with the next block of the message back at block 402. If all message blocks have been processed (e.g., hashed), then at block 406, FORS tree verifier 306 partition the message representative. At block 408, FORS tree verifier 306 regenerates the FORS public key using the FORS tree. In an implementation, regenerating the FORS public key is performed by processing one or more FORS roots. At block 410, if not all FORS roots are regenerated, then processing continues with the next FORS root back at block 408. If all FORS roots have been regenerated, then at block 412 hypertree verifier 308 regenerates the SPHINCS+ public key root using the hypertree. In an implementation, regenerating the SPHINCS+ public key root is performed by processing one or more layers of the hypertree. At block 414, if every layer of the hypertree is not yet generated, then processing continues with the next layer back at block 412. If every layer has been generated, then at block 416 hypertree verifier 308 compares the regenerated SPHINCS+ public key root with the input SPHINCS+ public key root from SPHINCS+ public key 316. At block 416, if the key roots do not match, then a failure (unsuccessful signature verification) indicator is returned at block 420. If the key roots do match, then a pass (successful signature verification) indicator is returned at block 418.

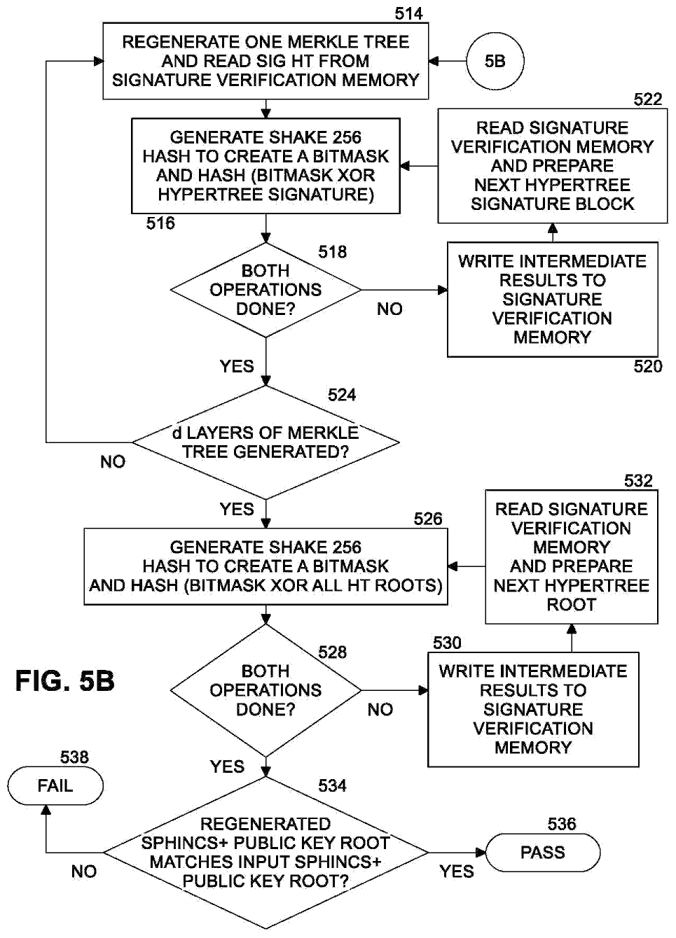

FIGS. 5A and 5B illustrates hypertree generation processing 500 according to an implementation. At block 502 on FIG. 5A, WOTS+ chains generator 310 of hypertree verifier 308 generates a WOTS+ chain. At block 504, hypertree verifier 308 directs SHA3 circuitry 302 to generate a SHAKE256 hash (using a WOTS+ address) to create a bitmask and generates the hash of the bitmask XOR the hypertree signature portion 317 of SPHINCS+ public key 316 (hash (bitmask XOR SIGHT)). At block 506, if both operations (bitmask generation and hash generation) are not done then at block 510 intermediate results are written to signature verification memory 314. At block 512, hypertree verifier 308 reads signature verification memory 314 to prepare the next hypertree signature block. Processing proceeds to block 504. At block 506, if both operations are done, then at block 508 WOTS+ chains generator determines if 2\hat{ }(h/d) public keys have been verified, where h is the height of the hypertree and d is the number of tree layers in the hypertree. If not, processing continues with block 502 and generation of another WOTS+ chain. Otherwise, processing continues with block 514 on FIG. 5B via connector 5B.

At block 514 of FIG. 5B, Merkle tree generator 312 of hypertree verifier 308 regenerates a Merkle tree and reads SIGHT from signature verification memory 314. At block 516, hypertree verifier 308 directs SHA3 circuitry 302 to generate a SHAKE256 hash to create a bitmask and generates the hash of the bitmask XOR hypertree signature portion 317 of SPHINCS+ public key (hash (bitmask XOR SIGHT)), resulting in a HT root. At block 518, if both operations (bitmask generation and hash generation) are not done then at block 520 intermediate results are written to signature verification memory 314. At block 522, hypertree verifier 308 reads signature verification memory 314 to prepare the next hypertree signature block. Processing proceeds to block 516. At block 518, if both operations are done, then processing continues with block 524. If d layers of the Merkle tree are not yet generated, then processing continues at block 514 with regeneration of the next Merkle tree. If d layers of the Merkle tree have been generated, then at block 526 hypertree verifier 308 directs SHA3 circuitry 302 to generate a SHAKE256 hash to create a bitmask and generates the hash of the bitmask XOR all HT roots (hash (bitmask XOR HT roots)). At block 528, if both operations (bitmask generation and hash generation) are not done then at block 530 intermediate results are written to signature verification memory 314. At block 532, hypertree verifier 308 reads signature verification memory 314 to prepare the next hypertree root. Processing proceeds to block 526. At block 528, if both operations are done, then processing continues with block 534. At block 534, hypertree verifier 308 compares the regenerated SPHINCS+ public key root to the input SPHINCS+ public key root. At block 534, if the key roots do not match, then a failure indicator (unsuccessful signature verification) is returned at block 538. If the key roots do match, then a pass (successful signature verification) indicator is returned at block 536.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

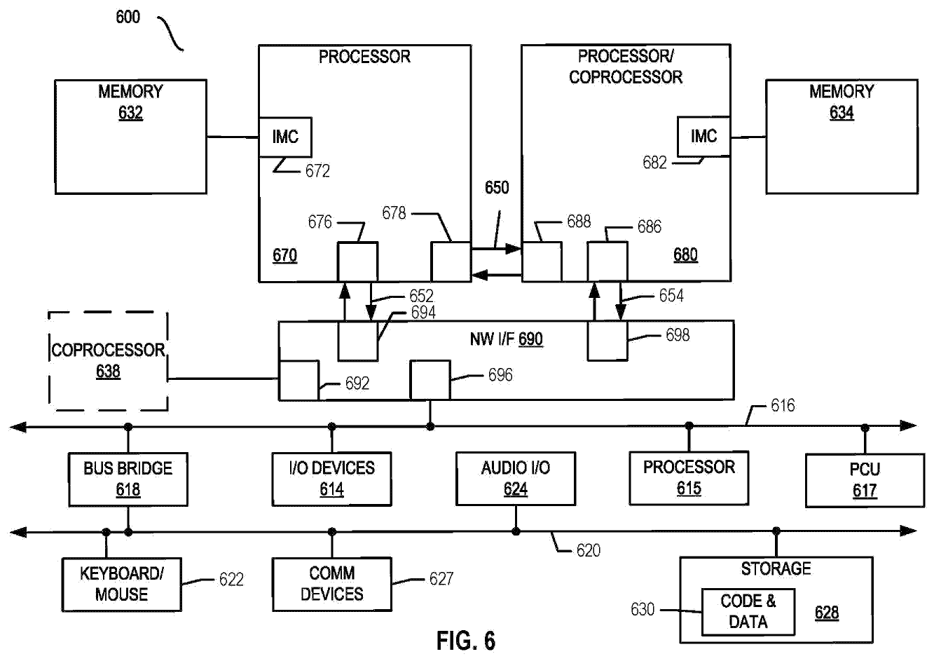

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

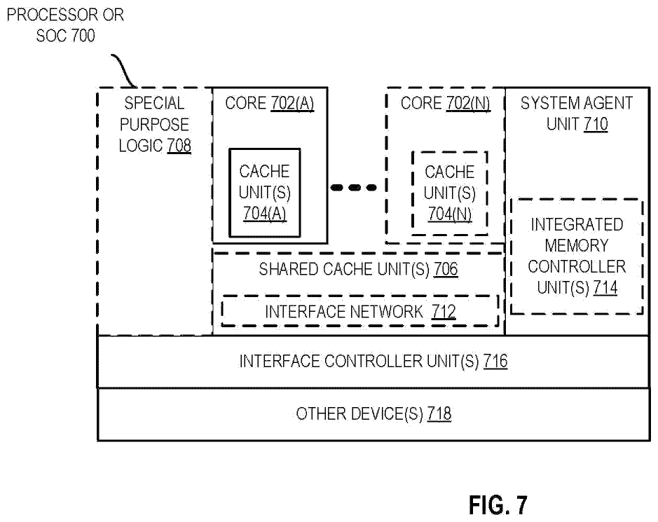

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

Example Core Architectures—In-order and out-of-order core block diagram.

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor 800 pipeline includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the processor 800 pipeline as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry.

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

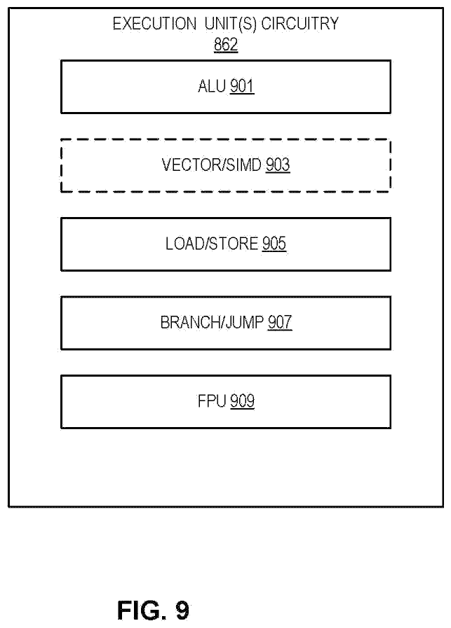

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and comprises a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 comprise control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 'ISAB08, or physical register file(s) circuitry 8 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

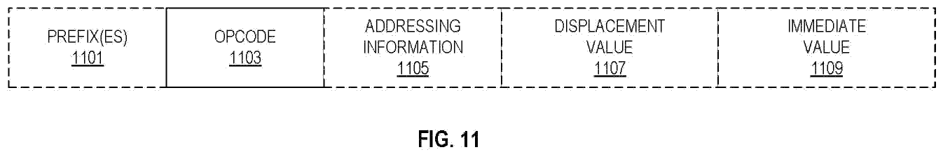

The addressing information field 1105 is used to address one or more operands of the instruction, such as a location in memory or one or more registers. FIG. 12 illustrates examples of the addressing information field 1105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both of these fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 1101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 1101) to allow for greater addressing. The base field 1256 specifies a base register to use. In some examples, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2^{scale}*index+base).

Some addressing forms utilize a displacement value to generate a memory address. For example, a memory address may be generated according to 2^{scale}*index+base+displacement, index*scale+ displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1105 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

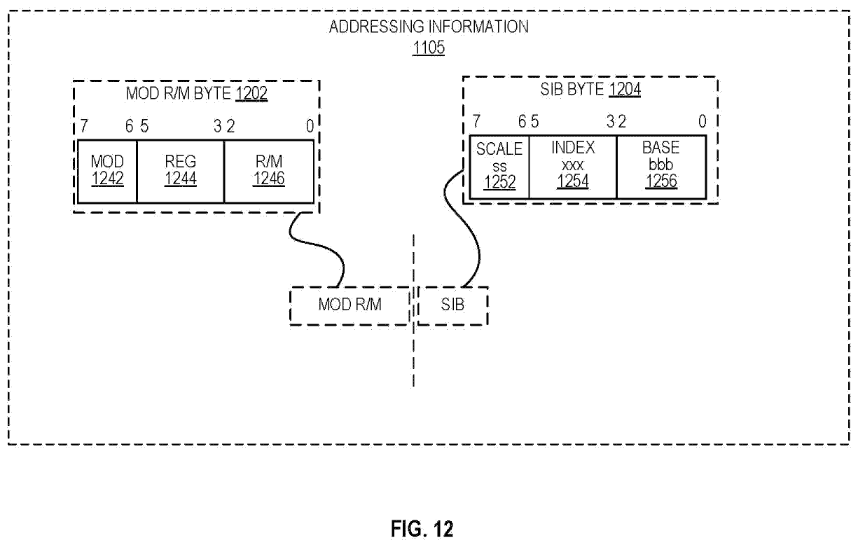

FIG. 13 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2+) registers to be addressed, whereas the MOD R/M reg field 1244 and MOD R/M R/M field 1246 alone can each only address 8 registers.

In the first prefix 1101(A), bit position 2 (R) may be an extension of the MOD R/M reg field 1244 and may be used to modify the MOD R/M reg field 1244 when that field encodes a general-purpose register, a 64-bit packed data register (e.g., a SSE register), or a control or debug register. R is ignored when MOD R/M byte 1202 specifies other registers or defines an extended opcode.

Bit position 1 (X) may modify the SIB byte index field 1254.

Bit position 0 (B) may modify the base in the MOD R/M R/M field 1246 or the SIB byte base field 1256; or it may modify the opcode register field used for accessing general purpose registers (e.g., general purpose registers 1025).

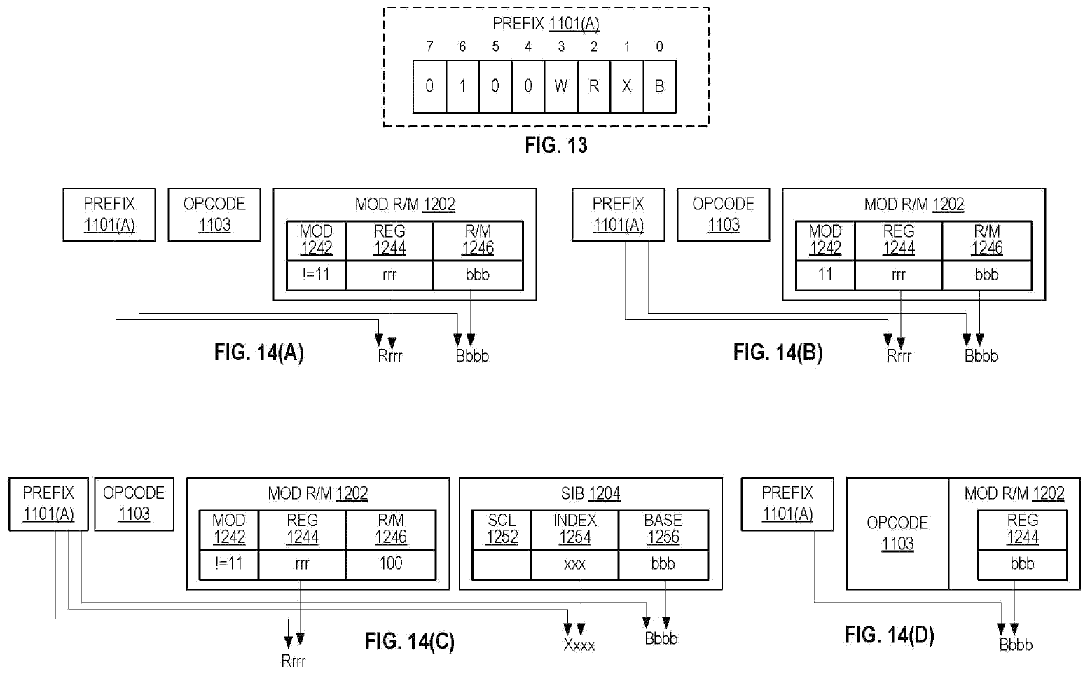

FIGS. 14(A)-(D) illustrate examples of how the R, X, and B fields of the first prefix 1101(A) are used. FIG. 14(A) illustrates R and B from the first prefix 1101(A) being used to extend the reg field 1244 and R/M field 1246 of the MOD R/M byte 1202 when the SIB byte 12 04 is not used for memory addressing. FIG. 14(B) illustrates R and B from the first prefix 1101(A) being used to extend the reg field 1244 and R/M field 1246 of the MOD R/M byte 1202 when the SIB byte 12 04 is not used (register-register addressing). FIG. 14(C) illustrates R, X, and B from the first prefix 1101(A) being used to extend the reg field 1244 of the MOD R/M byte 1202 and the index field 1254 and base field 1256 when the SIB byte 12 04 being used for memory addressing. FIG. 14(D) illustrates B from the first prefix 1101(A) being used to extend the reg field 1244 of the MOD R/M byte 1202 when a register is encoded in the opcode 1103.

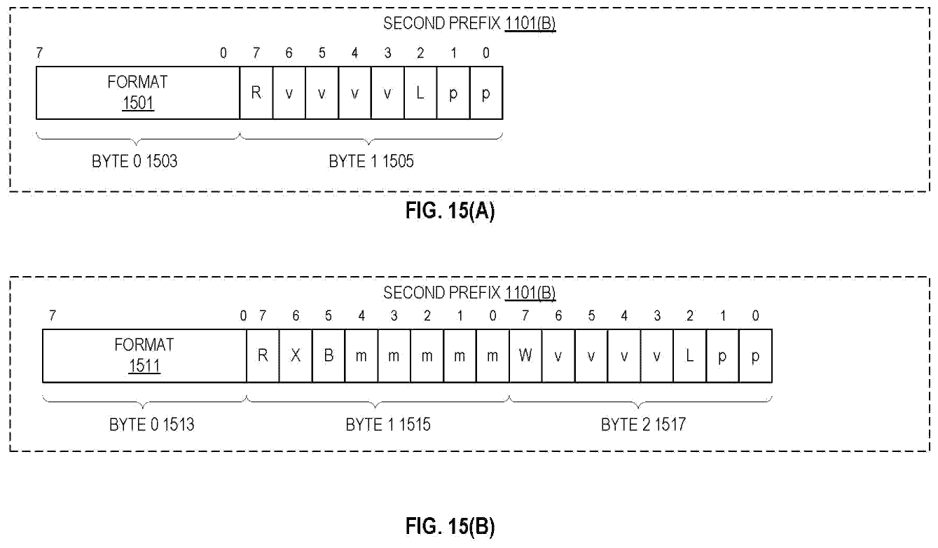

FIGS. 15(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1010) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand. The use of the second prefix 1101(B) enables operands to perform nondestructive operations such as A=B+C.

In some examples, the second prefix 1101(B) comes in two forms—a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 15(A) illustrates examples of a two-byte form of the second prefix 1101(B). In one example, a format field 1501 (byte 0 1503) contains the value C5H. In one example, byte 1 1505 includes an “R” value in bit[7]. This value is the complement of the “R” value of the first prefix 1101(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that support four operands, vvvv, the MOD R/M R/M field 1246 and the MOD R/M reg field 1244 encode three of the four operands. Bits[7:4] of the immediate value field 1109 are then used to encode the third source register operand.

FIG. 15(B) illustrates examples of a three-byte form of the second prefix 1101(B). In one example, a format field 1511 (byte 0 1513) contains the value C4H. Byte 1 1515 includes in bits[7:5] “R,” “X,” and “B” which are the complements of the same values of the first prefix 1101(A). Bits[4:0] of byte 1 1515 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1517 is used similar to W of the first prefix 1101(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that support four operands, vvvv, the MOD R/M R/M field 1246, and the MOD R/M reg field 1244 encode three of the four operands. Bits[7:4] of the immediate value field 1109 are then used to encode the third source register operand.

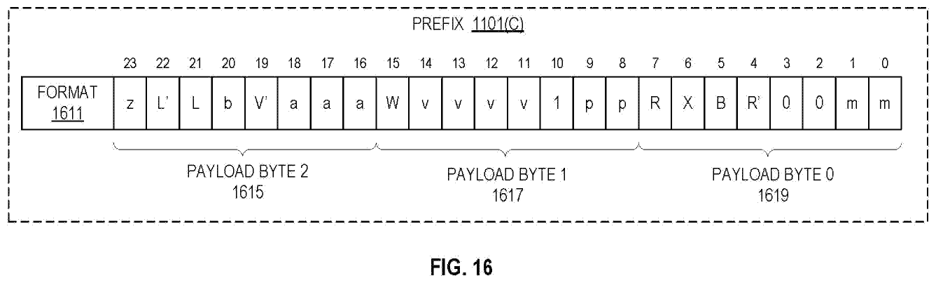

FIG. 16 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 10) or predication utilize this prefix. Opmask register allow for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4] (R′) allows access to the high 16 vector register set when combined with P[7] and the MOD R/M reg field 1244. P[6] can also provide access to a high 16 vector register when SIB-type addressing is not needed. P[7:5] comprise R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1101(A) and second prefix 1111(B) and may serve as an opcode extension bit or operand size promotion.

P[18:16] specify the index of a register in the opmask (writemask) registers (e.g., writemask/predicate registers 1015). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M reg | GPR, Vector | Destination or Source |
| VVVV | V′ | vvvv | | GPR, Vector | 2nd Source or Destination |
| RM | X | B | MOD R/M R/M | GPR, Vector | 1st Source or Destination |
| BASE | 0 | B | MOD R/M R/M | GPR | Memory addressing |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation or any other process, allows a processor or other electronic device that does not have a first ISA processor or core to execute the first ISA binary code 1706.

### Additional Notes and Examples

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions and coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

### EXAMPLES

Example 1 is an apparatus including a signature verification memory to store verification input data, the verification input data including a message, a public key, and a signature; Secure Hash Algorithm (SHA) circuitry to read input data from the signature verification memory, perform a SHA hash operation, and write output data to the signature verification memory, the reading, performing and writing being executed substantially in parallel; message representative generator circuitry to generate a message representative for the message using the SHA circuitry, the message representative including a first public key root; forest of random subsets (FORS) tree verification circuitry to partition the message representative and regenerate a FORS public key using a FORS tree, the partitioned message representative, and the SHA circuitry; and hypertree verification circuitry to regenerate a second public key root using the FORS public key, the message, and the signature through a hypertree and the SHA circuitry, return a first indicator of a successful verification of the signature in response to the first public key root matching the second public key root, and return a second indicator of an unsuccessful verification of the signature in response to the first public key root not matching the second public key root.

In Example 2, the subject matter of Example 1 may optionally include wherein the message is a SPHINCS+ message, the public key is a SPHINCS+ public key, and the signature is a SPHINCS+ signature. In Example 3, the subject matter of Example 1 may optionally include wherein the hypertree verification circuitry includes Winternitz one-time signature (WOTS+) chains generator circuitry to generate a plurality of WOTS+ public keys from the FORS public key using the SHA circuitry; and Merkle tree generator circuitry to verify a Merkle tree from the plurality of WOTS+ public keys. In Example 4, the subject matter of Example 1 may optionally include wherein the SHA circuitry writes output data to the signature verification memory in response to performing the SHA hash operation. In Example 5, the subject matter of Example 1 may optionally include wherein the SHA hash operation comprises a SHAKE256 hash function. In Example 6, the subject matter of Example 5 may optionally include wherein the SHAKE256 hash function comprises a SPHINCS+-SHAKE256-256s hash function. In Example 7, the subject matter of Example 1 may optionally include wherein the verification input data is received from at least one of a processor and an accelerator. In Example 8, the subject matter of Example 1 may optionally include wherein the message representative generator circuitry is to divide the message into a plurality of message blocks and write the plurality of message blocks to the SHA circuitry.

In Example 9, the subject matter of Example 8 may optionally include wherein the message representative generator circuitry is to concatenate a message block of the plurality of message blocks, the public key, and a first portion of the signature into a concatenated data item and write the concatenated data item to the SHA circuitry, and the SHA circuitry performs the SHA hash operation on the concatenated data item to generate output data. In Example 10, the subject matter of Example 1 may optionally include wherein the message representative generator circuitry, the (FORS) tree verification circuitry, and the hypertree verification circuitry perform non-SHA operations in parallel with the SHA circuitry performing SHA operations. In Example 11, the subject matter of Example 1 may optionally include wherein the SHA circuitry comprises a plurality of SHA circuits executing in parallel.

Example 12 is a computing system including a memory; and a processor, the processor including signature verification circuitry, the signature verification circuitry including a signature verification memory to store verification input data, the verification input data including a message, a public key, and a signature; Secure Hash Algorithm (SHA) circuitry to read input data from the signature verification memory, perform a SHA hash operation, and write output data to the signature verification memory, the reading, performing and writing being executed substantially in parallel; message representative generator circuitry to generate a message representative for the message using the SHA circuitry, the message representative including a first public key root; forest of random subsets (FORS) tree verification circuitry to partition the message representative and regenerate a FORS public key using a FORS tree, the partitioned message representative, and the SHA circuitry; and hypertree verification circuitry to regenerate a second public key root using the FORS public key, the message, and the signature through a hypertree and the SHA circuitry, return a first indicator of a successful verification of the signature in response to the first public key root matching the second public key root, and return a second indicator of an unsuccessful verification of the signature in response to the first public key root not matching the second public key root.

In Example 13, the subject matter of Example 12 may optionally include wherein the message is a SPHINCS+ message, the public key is a SPHINCS+ public key, and the signature is a SPHINCS+ signature. In Example 14, the subject matter of Example 12 may optionally include wherein the hypertree verification circuitry comprises: Winternitz one-time signature (WOTS+) chains generator circuitry to generate a plurality of WOTS+ public keys from the FORS public key using the SHA circuitry; and Merkle tree generator circuitry to verify a Merkle tree from the plurality of WOTS+ public keys. In Example 15, the subject matter of Example 12 may optionally include wherein the SHA circuitry writes output data to the signature verification memory in response to performing the SHA hash operation. In Example 16, the subject matter of Example 12 may optionally include wherein the SHA hash operation comprises a SHAKE256 hash function. In Example 17, the subject matter of Example 12 may optionally include wherein the SHAKE256 hash function comprises a SPHINCS+-SHAKE256-256s hash function.

Example 18 is a method including receiving verification input data, the verification input data including a message, a public key, and a signature; storing the message, the public key and the signature in a signature verification memory; generating a message representative from the message, the message representative including a first public key root, the generating including reading first input data from the signature verification memory, performing a first plurality of hash operations, and writing first output data to the signature verification memory, the reading, performing and writing being executed substantially in parallel; partitioning the message representative; regenerating a forest of random subsets (FORS) public key using a FORS tree and the partitioned message representative, the regenerating the FORS public key including reading second input data from the signature verification memory, performing a second plurality of hash operations, and writing second output data to the signature verification memory, the reading, performing and writing being executed substantially in parallel; regenerating a second public key root using the FORS public key, the message, and the signature through a hypertree, the regenerating the second public key root including reading third input data from the signature verification memory, performing a third plurality of hash operations, and writing third output data to the signature verification memory, the reading, performing and writing being executed substantially in parallel; and returning a first indicator of a successful verification of the signature in response to the first public key root matching the second public key root and returning a second indicator of an unsuccessful verification of the signature in response to the first public key root not matching the second public key root.

In Example 19, the subject matter of Example 18 may optionally include wherein the message is a SPHINCS+ message, the public key is a SPHINCS+ public key, and the signature is a SPHINCS+ signature. In Example 20, the subject matter of Example 18 may optionally include generating a plurality of Winternitz one-time signature (WOTS+) public keys from the FORS public key; and verifying a Merkle tree from the plurality of WOTS+ public keys. In Example 20, the subject matter of Example 18 may optionally include writing output data to the signature verification memory in response to performing the first, second, and third plurality of hash operations. In Example 22, the subject matter of Example 18 may optionally include receiving the verification input data from at least one of a processor and an accelerator. In Example 23, the subject matter of Example 18 may optionally include generating the message representative from the message in parallel with performing the first plurality of hash operations, regenerating the forest FORS public key using the FORS tree and the partitioned message representative in parallel with performing the second plurality of hash operations, and regenerating the second public key root using the FORS public key, the message, and the signature through the hypertree in parallel with performing the third plurality of hash operations.

Example 24 is an apparatus operative to perform the method of any one of Examples 18 to 23. Example 25 is an apparatus that includes means for performing the method of any one of Examples 18 to 23. Example 26 is an apparatus that includes any combination of modules and/or units and/or logic and/or circuitry and/or means operative to perform the method of any one of Examples 18 to 23. Example 27 is an optionally non-transitory and/or tangible machine-readable medium, which optionally stores or otherwise provides instructions that if and/or when executed by a computer system or other machine are operative to cause the machine to perform the method of any one of Examples 18 to 23.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a signature verification memory to store verification input data, the verification input data including a message, a public key, and a signature;
Secure Hash Algorithm (SHA) circuitry to read input data from the signature verification memory, perform a SHA hash operation, and write output data to the signature verification memory, the reading, performing and writing being executed substantially in parallel;
message representative generator circuitry to generate a message representative for the message using the SHA circuitry, the message representative including a first public key root;
forest of random subsets (FORS) tree verification circuitry to regenerate a FORS public key; and
hypertree verification circuitry to regenerate a second public key root and return an indicator of a successful verification of the signature in response to the first public key root matching the second public key root.

2. The apparatus of claim 1, wherein the message is a SPHINCS+ message, the public key is a SPHINCS+ public key, and the signature is a SPHINCS+ signature.

3. The apparatus of claim 1, wherein the hypertree verification circuitry comprises:
Winternitz one-time signature (WOTS+) chains generator circuitry to generate a plurality of WOTS+ public keys from the FORS public key using the SHA circuitry; and
Merkle tree generator circuitry to verify a Merkle tree from the plurality of WOTS+ public keys.

4. The apparatus of claim 1, wherein the SHA circuitry writes output data to the signature verification memory in response to performing the SHA hash operation.

5. The apparatus of claim 1, wherein the SHA hash operation comprises a SHAKE256 hash function.

6. The apparatus of claim 5, wherein the SHAKE256 hash function comprises a SPHINCS+-SHAKE256-256s hash function.

7. The apparatus of claim 1, wherein the verification input data is received from at least one of a processor and an accelerator.

8. The apparatus of claim 1, wherein the message representative generator circuitry is to divide the message into a plurality of message blocks and write the plurality of message blocks to the SHA circuitry.

9. The apparatus of claim 8, wherein the message representative generator circuitry is to concatenate a message block of the plurality of message blocks, the public key, and a first portion of the signature into a concatenated data item and write the concatenated data item to the SHA circuitry, and the SHA circuitry performs the SHA hash operation on the concatenated data item to generate output data.

10. The apparatus of claim 1, wherein the message representative generator circuitry, the (FORS) tree verification circuitry, and the hypertree verification circuitry perform non-SHA operations in parallel with the SHA circuitry performing SHA operations.

11. The apparatus of claim 1, wherein the SHA circuitry comprises a plurality of SHA circuits executing in parallel.

12. A computing system comprising:
a memory; and
a processor, the processor including signature verification circuitry, the signature verification circuitry including
a signature verification memory to store verification input data, the verification input data including a message, a public key, and a signature;
Secure Hash Algorithm (SHA) circuitry to read input data from the signature verification memory, perform a SHA hash operation, and write output data to the signature verification memory, the reading, performing and writing being executed substantially in parallel;
message representative generator circuitry to generate a message representative for the message using the SHA circuitry, the message representative including a first public key root;
forest of random subsets (FORS) tree verification circuitry to regenerate a FORS public key; and
hypertree verification circuitry to regenerate a second public key root using the FORS public key, the message, and the signature, return an indicator of a successful verification of the signature in response to the first public key root matching the second public key root.

13. The computing system of claim 12, wherein the message is a SPHINCS+ message, the public key is a SPHINCS+ public key, and the signature is a SPHINCS+ signature.

14. The computing system of claim 12, wherein the hypertree verification circuitry comprises:
Winternitz one-time signature (WOTS+) chains generator circuitry to generate a plurality of WOTS+ public keys from the FORS public key using the SHA circuitry; and
Merkle tree generator circuitry to verify a Merkle tree from the plurality of WOTS+ public keys.

15. The computing system of claim 12, wherein the SHA circuitry writes output data to the signature verification memory in response to performing the SHA hash operation.

16. The computing system of claim 12, wherein the SHA hash operation comprises a SHAKE256 hash function.

17. The computing system of claim 16, wherein the SHAKE256 hash function comprises a SPHINCS+-SHAKE256-256s hash function.

18. A method comprising:
receiving verification input data, the verification input data including a message, a public key, and a signature;
storing the message, the public key and the signature in a signature verification memory;
generating a message representative from the message, the message representative including a first public key root, the generating including reading first input data from the signature verification memory, performing a first plurality of hash operations, and writing first output data to the signature verification memory, the reading, performing and writing being executed substantially in parallel;
partitioning the message representative;
regenerating a forest of random subsets (FORS) public key using a FORS tree and the partitioned message representative, the regenerating the FORS public key including reading second input data from the signature verification memory, performing a second plurality of hash operations, and writing second output data to the signature verification memory, the reading, performing and writing being executed substantially in parallel;
regenerating a second public key root using the FORS public key, the message, and the signature through a hypertree, the regenerating the second public key root including reading third input data from the signature verification memory, performing a third plurality of hash operations, and writing third output data to the signature verification memory, the reading, performing and writing being executed substantially in parallel; and
returning a first indicator of a successful verification of the signature in response to the first public key root matching the second public key root and returning a second indicator of an unsuccessful verification of the signature in response to the first public key root not matching the second public key root.

19. The method of claim 18, wherein the message is a SPHINCS+ message, the public key is a SPHINCS+ public key, and the signature is a SPHINCS+ signature.

20. The method of claim 18, comprising:
generating a plurality of Winternitz one-time signature (WOTS+) public keys from the FORS public key; and
verifying a Merkle tree from the plurality of WOTS+ public keys.

21. The method of claim 18, comprising writing output data to the signature verification memory in response to performing the first, second, and third plurality of hash operations.

22. The method of claim 18, comprising receiving the verification input data from at least one of a processor and an accelerator.

23. The method of claim 18, comprising generating the message representative from the message in parallel with performing the first plurality of hash operations, regenerating the forest FORS public key using the FORS tree and the partitioned message representative in parallel with performing the second plurality of hash operations, and regenerating the second public key root using the FORS public key, the message, and the signature through the hypertree in parallel with performing the third plurality of hash operations.
